(19) United States
(12) Patent Application Publication
(10) Pub. No.: US 2013/0191497 A1
(43) Pub. Date: Jul. 25, 2013

(54) Storage and Transmission of Log Data In a Networked System

(71) Applicants: Eli M. Dow, Poughkeepsie, NY (US); Erin M. Farr, Poughkeepsie, NY (US); Douglas M. Zobre, Poughkeepsie, NY (US)

(72) Inventors: Eli M. Dow, Poughkeepsie, NY (US); Erin M. Farr, Poughkeepsie, NY (US); Douglas M. Zobre, Poughkeepsie, NY (US)

(73) Assignee: INTERNATIONAL BUSINESS MACHINES CORPORATION, Armonk, NY (US)

(21) Appl. No.: 13/357,794

(22) Filed: Jan. 25, 2012

(51) Int. Cl. G06F 15/16

(52) U.S. Cl. 709/217

(57) ABSTRACT

A method for storing log data in a networked storage system includes receiving one or more log data streams and storing the log data streams in a local memory location. The method also includes accessing the log data streams from the local memory location by a communications adapter and transmitting the log data streams to a storage system over a communications network by the communications adapter. The communications adapter is configured for one way communication with the storage system.

### BACKGROUND

The present disclosure relates to the field of computer data storage systems, and more specifically, to systems, methods and computer program products for storing log data in a networked storage system.

Many computer applications and operating systems produce log data during for tracking the use and performance of the application or system. This log data is stored by the computer system and can be analyzed to gather information about the performance of the program or system. In a large system that can include multiple systems running multiple applications that are all generating log data, the management, transmission and storage of the log data can consume valuable system resources.

In many current systems, a data logger is used to provide data logging for applications running in a single-system or multi-system sysplex. The data logger manages the tasks of saving the log data, retrieving the data and archiving the data. The data logger provides a single, merged, log, containing log data from multiple instances of an application within the sysplex. Log data managed by the logger may reside in multiple physical locations. The data logger utilizes standard networking infrastructure and protocols to manage the location of the data and the migration of that data from one location to another. As a result, multiple copies of the log stream data may be generated which can decrease system performance. In addition, the standard network protocols used by the data logger incur substantial overhead providing a quality of service not required by the data logger.

### SUMMARY

According to one embodiment, a method for storing log data in a networked storage system includes receiving one or more log data streams and storing the log data streams in a local memory location. The method also includes accessing the log data streams from the local memory location by a communications adapter and transmitting the log data streams to a storage system over a communications network by the communications adapter. The communications adapter is configured for one way communication with the storage system.

According to another embodiment, a computer program product for storing log data in a networked storage system includes a tangible storage medium readable by a processing circuit and storing instructions for execution by the processing circuit for performing a method including receiving one or more log data streams and storing the log data streams in a local memory location. The method also includes accessing the log data streams from the local memory location by a communications adapter and transmitting the log data streams to a storage system over a communications network by the communications adapter. The communications adapter is configured for one way communication with the storage system.

According to a further embodiment, a system for storing log data in a networked storage system includes one or more applications generating log data and a local memory operable for storing the log data generated by the one or more applications. The system also includes a communications adapter operable for accessing the local memory and transmitting the log data to a storage system, wherein the communications adapter is configured for one way communication with the storage system.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating a processing system and a storage system in accordance with an exemplary embodiment of the disclosure;

FIG. 2 is a flow diagram illustrating a method for storing log data in a networked storage system in accordance with an exemplary embodiment of the disclosure; and

FIG. 3 is a flow diagram illustrating another method for storing log data in a networked storage system in accordance with an exemplary embodiment of the disclosure.

### DETAILED DESCRIPTION

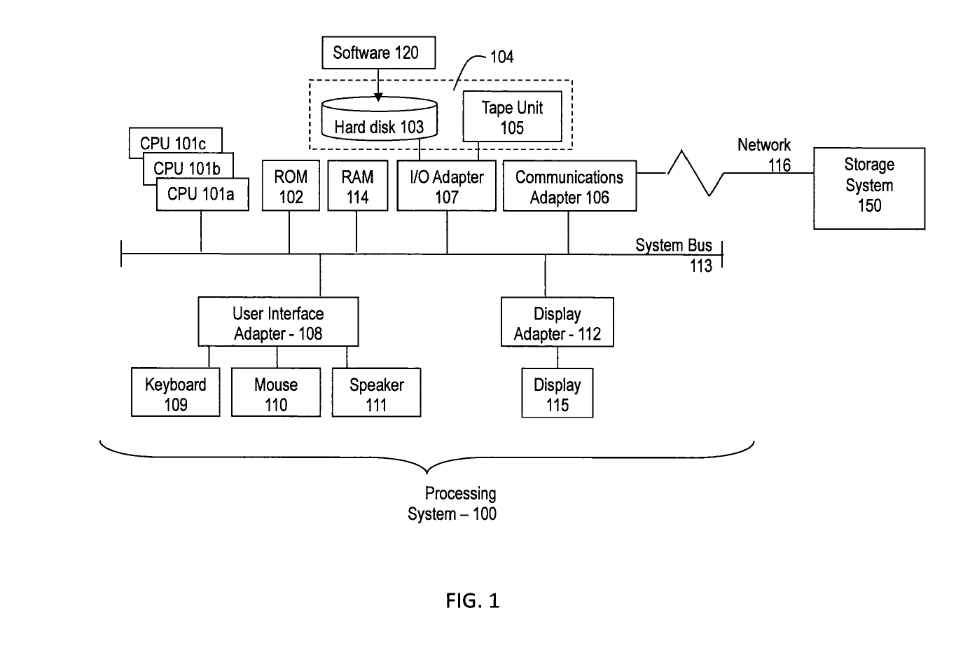

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network or communications adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Software 120 for execution on the processing system 100 may be stored in mass storage 104. A network adapter 106 interconnects bus 113 with an outside network 116 enabling data processing system 100 to communicate with one or more storage systems 150. The storage system 150 may include any type of processing system that is used to store or analyze data provided by the processing system 100. Accordingly, the storage system 150 may also include one or more central processing units, a system memory, a communications adapter and other components similar to those present in the processing system 100.

A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

In current data logging systems, as log data is written into a log stream, the log data is buffered, or copied, into one or more storage locations and these buffers are later processed by having the log data copied and sent over the network. In an exemplary embodiment, the log stream data can be placed into a storage location, which may include system memory 114 and mass storage 104, that is managed by the communications adapter 116. By allowing the communications adapter 116 to mange the storage location, the log stream data can be accessed and transmitted by the communications adapter 116 as soon as the log stream data is written, thereby avoiding the separate buffering of the log data.

In exemplary embodiments, the processing system 100 generates log stream data that may be stored on the storage system 150. The processing system 100 includes a data logger that is designed to minimize the number of copies of the log stream data that occur on the processing system 100 and to increase the performance of transmitting the log stream data over network 116 to the storage system 150. In one embodiment, once the log stream data is generated the data logger provides the log stream data directly to the communications adapter 106 for transmission across the network 116 to the storage system 150. By immediately writing the log data stream to the communications adapter 106, the data logger can reduce the number of times the log stream data is transferred within the processing system, thereby reducing the number of occurrences of the log stream data on the processing system. In one embodiment, the communications adapter 106 may monitor a register and when the register is read from or written to the communications adapter 106 may transmit the log stream data that has been written to the communications adapter 106.

In another embodiment, the data logger may store the log stream data on either the system memory 114 or the mass storage 104 and provide the address of the location that the log stream data was stored to the communications adapter 106. The communications adapter 106 is then able to directly access the either the system memory 114 or mass storage 104 to retrieve the log stream data for transmission to the storage system 150. By either providing the log stream data directly to the communications adapter 106 or storing the log stream data in a location accessible by the communications adapter 106, the data logger does not need to keep a copy of the log stream data in a buffer.

In an exemplary embodiment, the communications adapter 106 may be configured to access a portion of the system memory 114 and mass storage 104 which the data logger utilizes to store log stream data. The communications adapter 106 may be designed to retrieve the log stream data from the hard disk 103 or RAM 114 either periodically or upon the receipt of a command from the data logger. In one embodiment, communications adapter 106 can monitor the portion of the hard disk 103 or RAM 114 used by the data logger for storage of the log stream data and when data is written to a known storage location, the communications adapter 106 may retrieve and transmit the log stream data. Once the communications adapter 106 transmits the log stream data to the storage system 150, the log stream data can be removed from the hard disk 103 or RAM 114.

In exemplary embodiments, the communications adapter 106 may be configured to operate in a manner that minimizes the overhead associated with transmitting the log data to the storage system 150. For example, the communications adapter 106 may operate in a direct write outbound throughput mode and be configured to not allow incoming packets. In one embodiment, a full duplex network card can be modified through the use of a level one or level two protocol to alter the operation of the network card into a half duplex card that never relinquishes control of the network 116 to the storage system 150.

In exemplary embodiments, the communications protocol utilized by the communications adapter 106 may be configured to minimize the overhead associated with transmitting the log data to the storage system 150. In one embodiment, the communications protocol used by the communications adapter 106 does not include the use of acknowledgement messages, or ACKs, to ensure transmission of the log data is received by the storage system 150. The processing system 100 can be designed to maximize performance, as measured by throughput of log data, over reliability. Since the individual pieces of information generated and stored as log data are not critical, the loss of some log data is less important than maximizing the performance of the processing system 100. In addition, the protocol utilized by the communications adapter 106 may be configured to bypass multiple levels of buffering used by current logging systems to preserve messages for transmission or writing.

In exemplary embodiments, the communications adapter 106 may utilize a custom communications protocol that avoids transmission overhead associated caused by the packet overhead (e.g. header) associated with each layer of a traditional TCP/IP protocol. In addition, the communications adapter 106 may utilize a custom communications protocol that avoids the processing overhead associated with each layer of a traditional TCP/IP protocol. For example, the communications adapter 106 may be designed to support the transmission of variable size data packets by utilizing packet headers that specify the size of the log data payload that are being transmitted and written to the storage system 150.

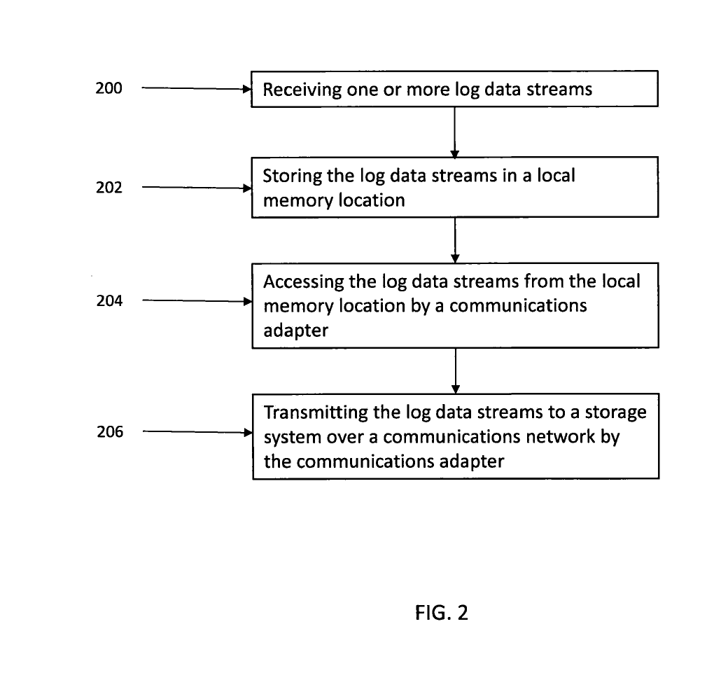

Referring now to FIG. 2, a flow diagram illustrating a method for storing log data in a networked storage system in accordance with an exemplary embodiment of the disclosure is shown. As shown at block 200, the method includes receiving one or more log data streams. The log data streams are then stored in a local memory location, as shown at block 202. Next, as shown at block 204, the method includes accessing the log data streams from the local memory location by a communications adapter. The method also includes transmitting the log data streams to a storage system over a communications network by the communications adapter, as shown at block 206.

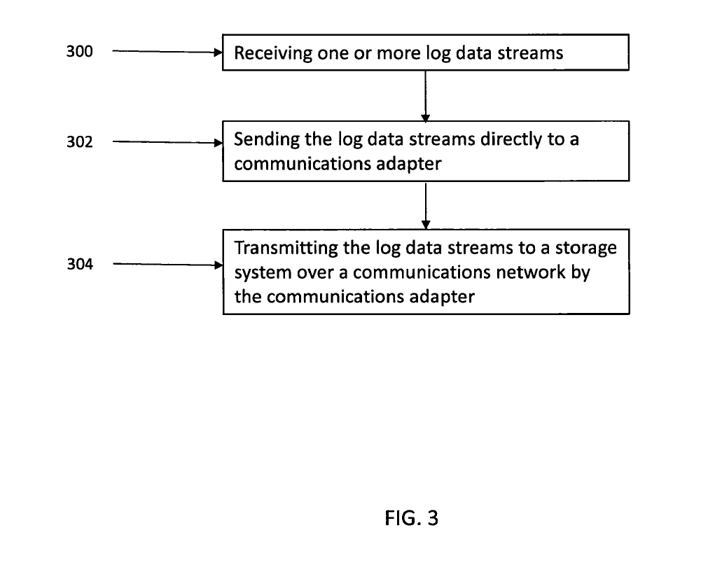

Referring now to FIG. 3, a flow diagram illustrating another method for storing log data in a networked storage system in accordance with an exemplary embodiment of the disclosure is shown. As shown at block 300, the method includes receiving one or more log data streams. Next, as shown at block 302, the method includes sending the log data streams directly to a communications adapter. The method also includes transmitting the log data streams to a storage system over a communications network by the communications adapter, as shown at block 304.

While referred to herein as a storage system 150, it will be understood by those of ordinary skill in the art that the storage system 150 may be any type of processing system that is capable of storing and/or analyzing the log data provided by the processing system 100. In exemplary embodiments, the storage system 150 includes a processor for performing analytics on the log data received from the processing system 100. Accordingly, the storage system 150 may also include one or more central processing units, a system memory, a communications adapter and other components similar to those present in the processing system 100. In addition, the storage system 150 may include a plurality of communications adapters and be designed to receive log data from a plurality of processing systems 100.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, SAN storage, servers logging data over networking (including those participating in broadcast network groups), a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method comprising:
receiving one or more log data streams;
storing the log data streams in a local memory location;
accessing the log data streams from the local memory location by a communications adapter; and
transmitting the log data streams to a storage system over a communications network by the communications adapter;
wherein the communications adapter is configured for one way communication with the storage system.

2. The method of claim 1, wherein the communications adapter is configured to utilize a communications protocol that does not include acknowledgement messages.

3. The method of claim 1, wherein the one or more data streams are erased from the local memory location when the log data streams are transmitted to the storage system.

4. The method of claim 1, wherein the communications adapter accessing the log data streams from the local memory location periodically.

5. The method of claim 1, wherein the communications adapter manages the local memory and transmits the log data to the storage system when log data is written to a specific local memory address.

6. A computer program product for storing log data in a networked storage system, the computer program product comprising:
a tangible storage medium readable by a processing circuit and storing instructions for execution by the processing circuit for performing a method comprising:
receiving one or more log data streams;
storing the log data streams in a local memory location;
accessing the log data streams from the local memory location by a communications adapter; and
transmitting the log data streams to a storage system over a communications network by the communications adapter;
wherein the communications adapter is configured for one way communication with the storage system.

7. The computer program product of claim 6, wherein the communications adapter is configured to utilize a communications protocol that does not include acknowledgement messages.

8. The computer program product of claim 6, wherein the one or more data streams are erased from the local memory location when the log data streams are transmitted to the storage system.

9. The computer program product of claim 6, wherein the communications adapter accessing the log data streams from the local memory location periodically.

10. The computer program product of claim 6, wherein the communications adapter manages the local memory and transmits the log data to the storage system when log data is written to a specific local memory address.

11. A system comprising:
a processing system comprising:
one or more applications generating log data;
a local memory operable for storing the log data generated by the one or more applications;
a communications adapter operable for accessing the local memory and transmitting the log data to a storage system, wherein the communications adapter is configured for one way communication with the storage system.

12. The system of claim 11, wherein the communications adapter is configured to utilize a communications protocol that does not include acknowledgement messages.

13. The system of claim 11, wherein the one or more data streams are erased from the local memory location when the log data streams are transmitted to the storage system.

14. The system of claim 11, wherein the communications adapter accessing the log data streams from the local memory location periodically.

15. The system of claim 11, wherein the communications adapter manages the local memory and transmits the log data to the storage system when log data is written to a specific local memory address.
